(19) United States
(12) Patent Application Publication
(10) Pub. No.: US 2006/0095454 A1
(43) Pub. Date: May 4, 2006

(54) System and method for secure collaborative terminal identity authentication between a wireless communication device and a wireless operator

(75) Inventors: Narendar Shankar, Dallas, TX (US); Erdal Paksoy, Richardson, TX (US); Derrill Sturgeon, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/978,276

(22) Filed: Oct. 29, 2004

(51) Int. Cl. G06F 17/30

(52) U.S. Cl. 707/101

(57) ABSTRACT

Systems and methods for providing a wireless communication device with secure terminal identity information and secure collaborative terminal identity authentication between the wireless communication device and a wireless operator. In one embodiment, the system for providing a wireless communication device with secure terminal identity information includes: (1) a public key generator configured to generate a unique public key and a unique private key based on an identity of the wireless communication device and cause the private key to be stored within a secure execution environment of the wireless communication device and (2) a certificate generator coupled to the public key generator and configured to create a device-bound certificate based on the identity and cause the device-bound certificate to be stored within the secure execution environment.

### TECHNICAL FIELD OF THE INVENTION

The present invention is directed, in general, to wireless telecommunications and, more specifically, to a system and method for secure collaborative terminal identity authentication between a wireless communication device and a wireless operator.

### BACKGROUND OF THE INVENTION

“Cloning” poses a serious problem for operators of wireless telephone networks. Cloning occurs when a counterfeit wireless telephone is programmed to disguise itself so it appears to a network to be a duly subscribed, genuine telephone. The wireless network cannot tell that the telephone is counterfeit and thus provides wireless services to the counterfeit telephone. This leads to a revenue loss for wireless communication device manufacturers, since counterfeit wireless communication devices are branded with the logos of well-known wireless telephone manufacturers to make them look like name brands and sold at lower prices than the genuine telephones. This may also allow wireless calls to be made with, of course, no intention of paying the operator.

To understand cloning, one should first understand how wireless telephones authenticate themselves with a network to obtain services. All wireless telephones are assigned a unique number at their time of manufacture. When the wireless telephone adheres to the predominantly American Frequency Division Multiple Access (FDMA), Time Division Multiple Access (TDMA) or Code Division Multiple Access (CDMA) standards, the unique number is known as an Electronic Serial Number (ESN). When the wireless telephone adheres to the predominantly European Groupe Speciale Mobile (GSM) standard, the unique number is known as an International Mobile Equipment Identity (IMEI) number. To keep the present discussion as simple as possible, however, the unique number will be generically referred to herein as an “ESN/IMEI” number.

To originate a call through a wireless network, a wireless telephone transmits its ESN/IMEI number and a unique Mobile Identification Number (MIN), which amounts to its telephone number, to the wireless network. The wireless network confirms that the ESN/IMEI number and the MIN properly correspond to one another and further to a duly subscribed telephone. If so, the network grants access to services so the call can be made. If not, the network refuses access.

Unfortunately, cloning does not involve anything so obvious as physical theft of the genuine telephone from its user. Instead, since the genuine telephone necessarily transmits its ESN/IMEI number and MIN to the wireless network every time it begins to make a call, one need only use readily available, but decidedly illegal, equipment to intercept the ESN/IMEI number and MIN and program them into a suitable counterfeit telephone. From that point forward, the counterfeit telephone transmits exactly the same numbers as the genuine one, and the wireless network has no mechanism to discern the difference.

Some efforts have been made to inhibit cloning. Even though ESN/IMEI numbers are not secret and are in fact typically printed on the telephone and its packaging, cloning is sometimes inhibited by not broadcasting them in the open. It is inherently more difficult to intercept ESN/IMEI numbers and MINs from digital telephones than from analog telephones because CDMA and GSM transmissions are harder to intercept. Still, digital telephones remain quite clonable. Some digital telephones encrypt their ESN/IMEI numbers during transmission, but the secret keys used to perform such encryption are vulnerable to compromise. Furthermore, the premises where operators program genuine telephones may not remain secure. Lists of keys, ESN/IMEI numbers and MINs can be obtained in bulk.

What is needed in the art is a more secure way to program wireless communication devices, such as wireless telephones, such that cloning by bulk theft is frustrated. What is further needed in the art is a more secure way for wireless communication devices to authenticate themselves to a wireless network such that cloning by interception becomes difficult and preferably infeasible.

### SUMMARY OF THE INVENTION

To address the above-described deficiencies of the prior art, the present invention provides systems and methods for providing a wireless communication device with secure terminal identity information and secure collaborative terminal identity authentication between the wireless communication device and a wireless operator.

In one aspect, the present invention provides a system for providing a wireless communication device with secure terminal identity information. In one embodiment, the system includes: (1) a public key generator configured to generate a unique public key and a unique private key based on an identity of the wireless communication device and cause the private key to be stored within a secure execution environment of the wireless communication device and (2) a certificate generator coupled to the public key generator and configured to create a device-bound certificate based on the identity and cause the device-bound certificate to be stored within the secure execution environment.

In another aspect, the present invention provides a method of providing a wireless communication device with secure terminal identity information. In one embodiment, the method includes: (1) generating a unique public key and a corresponding unique private key for the wireless communication device outside the wireless communication device, (2) creating a device-bound certificate based on an identity of the wireless communication device and (3) causing the private key and the device-bound certificate to be stored within a secure execution environment of the wireless communication device.

In yet another aspect, the present invention provides a system for secure collaborative terminal identity authentication between a wireless communication device and a wireless operator. In one embodiment, the system includes: (1) a challenge receiver operable within the wireless communication device and configured to receive a challenge from the wireless operator perhaps encrypted with a public key of the wireless communication device and (2) a response generator operable within the wireless communication device and configured to generate a response by digitally signing the challenge with a private key of the wireless communication device within a secure execution environment thereof.

In still another aspect, the present invention provides a method of secure collaborative terminal identity authentication between a wireless communication device and a wireless operator. In one embodiment, the method includes: (1) receiving a challenge from the wireless operator perhaps encrypted with a public key of the wireless communication device and (2) generating a response by digitally signing the challenge with a private key of the wireless communication device within a secure execution environment thereof.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of one embodiment of a wireless infrastructure containing a system for providing a wireless communication device with secure terminal identity information and secure collaborative terminal identity authentication between the wireless communication device and a wireless operator constructed according to the principles of the present invention;

FIG. 2 illustrates a schematic diagram featuring the wireless communication device of FIG. 1 in greater detail;

FIG. 3A illustrates a block diagram of one embodiment of a system for providing a wireless communication device with secure terminal identity information constructed according to the principles of the present invention;

FIG. 3B illustrates a block diagram of one embodiment of a system for providing a secure collaborative terminal identity authentication between a wireless communication device and a wireless operator constructed according to the principles of the present invention;

FIG. 4 illustrates a flow diagram of one embodiment of a method of providing a wireless communication device with secure terminal identity information carried out according to the principles of the present invention;

FIG. 5 illustrates a flow diagram of another embodiment of a method of providing a wireless communication device with secure terminal identity information carried out according to the principles of the present invention; and

FIG. 6 illustrates a flow diagram of one embodiment of a method of secure collaborative terminal identity authentication between a wireless communication device and a wireless operator carried out according to the principles of the present invention.

### DETAILED DESCRIPTION

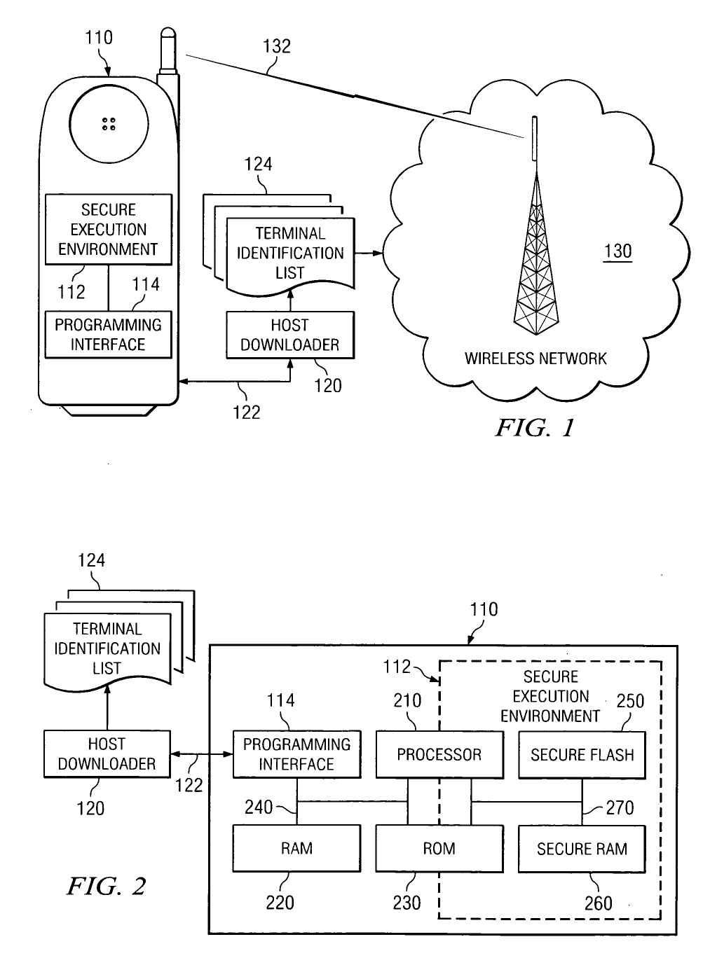

Referring initially to FIG. 1, illustrated is a schematic diagram of one embodiment of a wireless infrastructure containing a system for providing a wireless communication device with secure terminal identity information constructed according to the principles of the present invention. The wireless infrastructure also contains a system for providing secure collaborative terminal identity authentication between the wireless communication device and a wireless operator constructed according to the principles of the present invention.

FIG. 1 illustrates a mobile communication device 110, which is specifically a mobile telephone. The mobile communication device 110 contains a secure execution environment, or “SEE,” 112. Those skilled in the pertinent art are aware that an SEE (which may be hardware-based) is designed to perform according to the following objectives: (1) programs are authenticated and therefore free of unexpected code before being admitted to run within the SEE, (2) programs and data within the SEE are free from unwanted interference from outside the SEE and (3) programs and data within the SEE cannot be read from outside the SEE. An elaborate authentication process, often involving permissions and digital signatures, is employed to meet all three objectives. Further, components within the SEE are isolated from user-accessible memory, buses or external pins to meet the second and third objectives. For this reason and as will be seen in FIG. 2, SEEs are often provided with their own isolated, secure memory and buses. In the illustrated embodiment, the SEE 112 serves to protect secret and private keys and applications that use such keys.

In the illustrated embodiment, the wireless communication device is further an Open Multimedia Applications Platform (OMAP) device. Those skilled in the pertinent art understand that OMAP devices provide an open application programming interface for accommodating applications written by third-party developers. As is also well known, OMAP devices are designed to operate in public and secure modes. In the latter, an SEE is maintained.

A conventional programming interface 114 is coupled to the SEE 112, allowing the wireless communication device 110 to be programmed. Those skilled in the pertinent art are familiar with programming interfaces and their use, so the programming interface 114 will not be further described here.

A host downloader 120 performs the function of programming the wireless communication device 110. The term “host downloader” is defined to include any secure servers that may be associated with it. Those skilled in the pertinent art understand that the host downloader is responsible for providing an image that is written, or “flashed,” into flash memory (not shown, but detailed in FIG. 2) within the wireless communication device 110 via a programming link 122. The image typically contains applications that are to execute within the wireless communication device 110. If the wireless communication device in question is equipped with an SEE, those applications often include secure libraries, which are designed to be authenticated and enter the SEE for execution therein. In the specific context of the present invention, one or more secure libraries are included in the image and are intended to execute within the SEE 112. The function of one of those secure libraries will be described below.

The illustrated embodiment of the host downloader 120 produces a terminal identification, or TI, list 124, which amounts to a database of records, or “tuples,” of data pertaining to each wireless communication device 110 the host downloader 120 has programmed. A wireless operator (represented by a wireless network 130) uses the TI list 124 to authenticate wireless communication devices as they request access to the wireless network 130. A wireless transmission 132 is intended to represent the process of authentication that occurs.

Turning now to FIG. 2, illustrated is a schematic diagram featuring the wireless communication device of FIG. 1 in greater detail. The wireless communication device 110 is shown with its SEE 112 and programming interface 114. The host downloader 120 and associated programming link 122 and TI list 124 are also shown.

The wireless communication device 110 includes a processor 210, public random access memory (RAM) 220 and read-only memory (ROM) 230. An public bus 240 couples the processor 210 to the public RAM and ROM 230. Within the SEE 112 are secure flash memory 250 and secure RAM 260. A secure bus 270 couples the ROM 230, flash memory 250 and secure RAM 260. The public bus 240 and secure bus 270 are physically separate from one another to prevent signals traversing the secure bus 270 from being intercepted via the public bus 240. Further, the processor 210 and ROM 230 are illustrated as straddling the SEE 112, since they are capable of operating both outside of the SEE 112 in an public mode and within the SEE 112 in a secure mode.

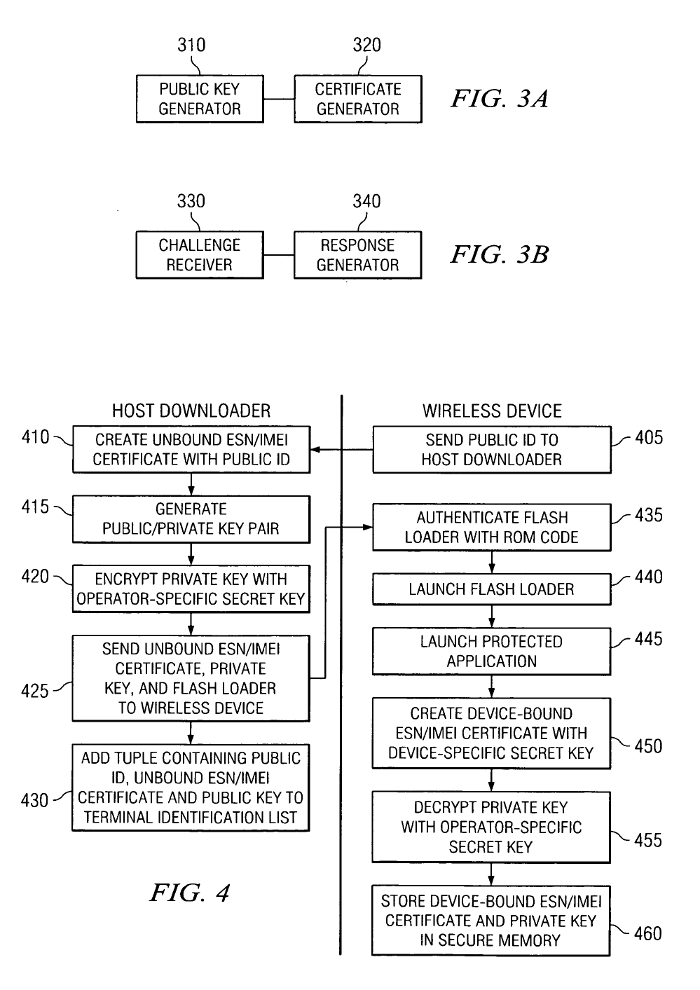

Turning now to FIG. 3A, illustrated is a block diagram of one embodiment of a system for providing a wireless communication device with secure terminal identity information constructed according to the principles of the present invention. The system includes a public key generator 310. The public key generator 310 is configured to generate a unique public key and a unique private key based on an identity of the wireless communication device. In an embodiment to be described below, the identity is the public identification, or “ID,” of the wireless communication device 110. The public key generator further causes the private key to be stored within a secure execution environment of the wireless communication device.

In one embodiment, the public key generator 310 resides within the host downloader 120 of FIGS. 1 and 2, and the private key is transmitted in a secure manner from the host downloader 120 to the wireless communication device 110 so as not to compromise the private key before it is safely lodged in the wireless communication device's SEE 112. In an embodiment to be described below, the private key is secured by encrypting it using an operator-specific or telephone manufacturer-specific secret key preprogrammed into the wireless communication device 110. Tacitly underlying this embodiment is the assumption that the wireless communication device 110 is either incapable of internally generating public and private keys (perhaps due to processor or memory limitations) or that the required key generation steps can be performed in the host downloader 120 in a more commercially tolerable time.

In an alternative embodiment, the public key generator 310 resides within the wireless communication device's SEE 112. The advantage of this embodiment is that the private key can remain within the SEE 112 and therefore secure. This embodiment assumes that the wireless communication device 110 is capable of internally generating public and private keys and that the required key generation steps can be performed in a commercially tolerable time.

The system further includes a certificate generator 320. The certificate generator 320 is coupled to the public key generator 310. The certificate generator 320 is configured to create a device-bound certificate based on the identity of the wireless communication device 110. In an embodiment to be described below, the identity is a device-specific secret key preprogrammed into the wireless communication device 110. The certificate generator 320 is further configured to cause the device-bound certificate to be stored within the SEE 112.

Turning now to FIG. 3B, illustrated is a block diagram of one embodiment of a system for providing a secure collaborative terminal identity authentication between a wireless communication device and a wireless operator constructed according to the principles of the present invention. The system includes a challenge receiver 330. The challenge receiver 330 is operable within the wireless communication device 110 of FIGS. 1 and 2. The challenge receiver 330 is configured to receive a challenge from the wireless operator. The challenge perhaps has been encrypted with a public key of the wireless communication device. However, encryption of the challenge is not necessary to the present invention.

The system further includes a response generator 340. The response generator 340 is also operable within the wireless communication device. The response generator 340 is configured to generate a response to the challenge by digitally signing the challenge with a private key of the wireless communication device within a secure execution environment thereof.

In the specific embodiment of FIG. 3B, both the challenge receiver 330 and the response generator 340 operate within the SEE 112 of FIGS. 1 and 2. Those skilled in the pertinent art will understand, however, that encryption security can be maintained by merely retaining the private key within the SEE 112 and performing all cryptographic operations with respect thereto within the SEE 112.

Turning now to FIG. 4, illustrated is a flow diagram of one embodiment of a method of providing a wireless communication device with secure terminal identity information carried out according to the principles of the present invention. For ease of understanding, the method is visually divided in FIG. 4 between the two apparatus involved: the host downloader 120 of FIGS. 1 and 2 and the wireless communication device 110 of FIGS. 1 and 2. Recall that the programming link 122 of FIG. 1 couples the host downloader to the wireless communication device during programming.

In a step 405, the wireless communication device sends its preprogrammed public ID to the host downloader. The host downloader responds in a step 410 by creating from the public ID an ESN/IMEI certificate that is not bound to the wireless communication device. In a step 415, the host downloader also generates a public/private key pair based on the public ID. Then, in a step 420, the host downloader uses an operator-specific or telephone manufacturer-specific secret key to encrypt the private key just generated. The encryption is designed temporarily to protect the private key during its journey into the SEE of the wireless communication device.

Next, in a step 425, the host downloader sends the unbound ESN/IMEI certificate, the encrypted private key and a flash memory loader (a software program containing an image to be loaded into the flash memory of the wireless communication device) to the wireless communication device. Then, in a step 430, the host downloader adds a record (tuple) containing the public ID, the unbound ESN/IMEI certificate and the public key to the TI list that will eventually be provided to the wireless network for use during authentication. Advantageously, nothing in the TI list is required to remain secure.

The wireless communication device receives the transmission from the host downloader and, in a step 435, authenticates the flash loader with code stored in its ROM and enters a protected mode of operation (the SEE). Then, in a step 440, the wireless communication device launches the flash loader which, in turn, causes a secure library to be launched within the SEE in a step 445. Next, in a step 450, the secure library takes the unbound ESN/IMEI certificate and uses the device-specific secret key with which it has been preprogrammed to create a device-bound ESN/IMEI certificate.

In a step 455, the secure library uses the operator-specific or wireless communication device manufacturer-specific secret key with which it has been preprogrammed to decrypt the private key that the host downloader had generated. Finally, in a step 460, the device-bound ESN/IMEI certificate and the private key are caused to be stored in the SEE, and more specifically in the flash memory contained within the SEE. The wireless communication device is now loaded and ready for operation, at least with respect to the functions contemplated by the present invention.

The present invention also encompasses a variation of the method of FIG. 4. Instead of the host downloader creating an unbound ESM/IMEI certificate to the wireless communication device (thereby tasking the wireless communication device with creating a device-bound ESN/IMEI certificate from the unbound ESN/IMEI certificate), the host downloader may use the wireless communication device's public ID to create directly a device-bound ESN/IMEI certificate. The host downloader may then transmit the device-bound ESN/IMEI certificate to the wireless communication device, which the wireless communication device needs only to store in its SEE.

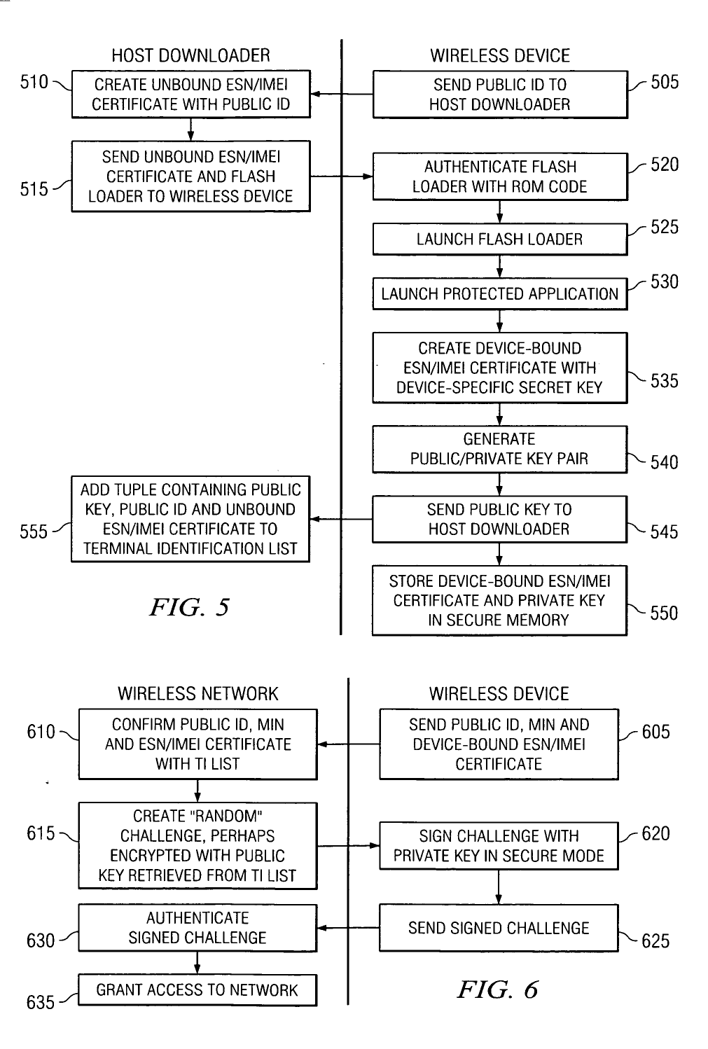

Turning now to FIG. 5, illustrated is a flow diagram of another embodiment of a method of providing a wireless communication device with secure terminal identity information carried out according to the principles of the present invention. As with FIG. 4, the method is visually divided in FIG. 5 between the two apparatus involved: the host downloader 120 of FIGS. 1 and 2 and the wireless communication device 110 of FIGS. 1 and 2.

In a step 505, the wireless communication device sends its preprogrammed public ID to the host downloader. The host downloader responds in a step 510 by creating from the public ID an ESN/IMEI certificate that is not bound to the wireless communication device. In a step 515, the host downloader sends the unbound ESN/IMEI certificate and a flash memory loader to the wireless communication device.

The wireless communication device receives the transmission from the host downloader and, in a step 520, authenticates the flash loader with code stored in its ROM and enters a protected mode of operation (the SEE). Then, in a step 525, the wireless communication device launches the flash loader which, in turn, causes a secure library to be launched within the SEE in a step 530. Next, in a step 535, the secure library takes the unbound ESN/IMEI certificate and uses the device-specific secret key with which it has been preprogrammed to create a device-bound ESN/IMEI certificate.

In a step 540, the wireless communication device generates a public/private key pair based on its preprogrammed public ID. Then, in a step 545, the wireless communication device transmits the public key to the host downloader. Since the key being transmitted is public, the wireless communication device does not need to encrypt it beforehand.

In a step 550, the device-bound ESN/IMEI certificate and the private key are caused to be stored in the SEE, and more specifically in the flash memory contained within the SEE.

Finally, in a step 555, the host downloader adds a record (tuple) containing the public ID, the unbound ESN/IMEI certificate and the public key to the TI list that will eventually be provided to the wireless network for use during authentication. Again, nothing in the TI list is required to remain secure. And as before, the wireless communication device is now loaded and ready for operation, at least with respect to the functions contemplated by the present invention.

Turning now to FIG. 6, illustrated is a flow diagram of one embodiment of a method of secure collaborative terminal identity authentication between a wireless communication device and a wireless operator carried out according to the principles of the present invention. The method is visually divided in FIG. 6 between the two apparatus involved: the wireless network 130 of FIG. 1 and the wireless communication device 110 of FIGS. 1 and 2.

The method begins in a step 605 when a wireless communication device requests access to wireless network services. The wireless communication device sends its public ID, MIN and the ESN/IMEI to the wireless network. In a step 610, the wireless network uses the TI list it has available to confirm that the public ID, MIN and ESN/IMEI. Assuming the wireless communication device passes this threshold test of authenticity, the wireless network generates a “random” challenge and optionally encrypts the challenge in a step 615. “Random” is in quotes, because the challenge need not be statistically random; in the illustrated embodiment the challenge is pseudorandom, which is satisfactory. The wireless network transmits the challenge to the wireless communication device.

In a step 620, the wireless communication device receives the challenge into its SEE, where it forms a response to the challenge by digitally signing it with its stored private key. Those skilled in the pertinent art are familiar with the concept of digitally signing for purposes of generating responses to challenges. Then, in a step 625, the mobile communication device sends the response (signed challenge) back to the wireless network. In a step 630, the wireless network authenticates the response. Those skilled in the pertinent art are also familiar with the manner in which responses are authenticated. If the response is authentic, the wireless network grants access in a step 635. Otherwise, the wireless network refuses access.

While the methods disclosed herein have been described and shown with reference to particular steps performed in a particular order, those skilled in the pertinent art will understand that these steps may be combined, subdivided, or reordered to form an equivalent method without departing from the teachings of the present invention. Accordingly, unless specifically indicated herein, the order and the grouping of the steps are not limitations of the present invention.

Although the present invention has been described in detail, those skilled in the art should understand that they can make various changes, substitutions and alterations herein without departing from the spirit and scope of the invention in its broadest form.

What is claimed is:

1. A system for providing a wireless communication device with secure terminal identity information, comprising:
a public key generator configured to generate a unique public key and a unique private key for said wireless communication device and cause said private key to be stored within a secure execution environment of said wireless communication device; and
a certificate generator coupled to said public key generator and configured to create a device-bound certificate based on an identity of said wireless communication device and cause said device-bound certificate to be stored within said secure execution environment.

2. The system as recited in claim 1 wherein said public key generator executes in a host downloader to generate said unique public key and said unique private key and encrypts said private key with a selected one of an operator-specific secret key and a wireless communication device manufacturer-specific secret key before transmitting said private key toward said secure execution environment.

3. The system as recited in claim 1 wherein said public key generator executes in said secure execution environment to generate said unique public key and said unique private key.

4. The system as recited in claim 1 wherein said certificate generator operates in a host downloader to create said device-bound certificate.

5. The system as recited in claim 1 wherein said device-bound certificate is based on a device-specific secret key preprogrammed into said secure execution environment.

6. A method of providing a wireless communication device with secure terminal identity information, comprising:
generating a unique public key and a corresponding unique private key for said wireless communication device outside said wireless communication device;
creating a device-bound certificate based on an identity of said wireless communication device; and
causing said private key and said device-bound certificate to be stored within a secure execution environment of said wireless communication device.

7. The method as recited in claim 6 wherein said generating is carried out in a host downloader and said method further comprises encrypting said private key with a selected one of an operator-specific secret key and a wireless communication device manufacturer-specific secret key before transmitting said private key toward said secure execution environment.

8. The method as recited in claim 6 wherein said generating is carried out in said secure execution environment.

9. The method as recited in claim 6 wherein said certificate generator operates in a host downloader to create said device-bound certificate.

10. The method as recited in claim 6 wherein said device-bound certificate is based on a device-specific secret key preprogrammed into said secure execution environment.

11. A system for secure collaborative terminal identity authentication between a wireless communication device and a wireless operator, comprising:
a challenge receiver operable within said wireless communication device and configured to receive a challenge from said wireless operator; and
a response generator operable within said wireless communication device and configured to generate a response by digitally signing said challenge with a private key of said wireless communication device within a secure execution environment thereof.

12. The system as recited in claim 11 wherein said challenge is at least pseudorandom.

13. The system as recited in claim 11 wherein said challenge is encrypted with a public key unique to said wireless communication device.

14. The system as recited in claim 11 wherein said challenge is received in response to an access request by said wireless communication device containing a public ID thereof.

15. The system as recited in claim 11 wherein said wireless communication device is a wireless telephone.

16. A method of secure collaborative terminal identity authentication between a wireless communication device and a wireless operator, comprising:
receiving a challenge from said wireless operator; and
generating a response by digitally signing said challenge with a private key of said wireless communication device within a secure execution environment thereof.

17. The method as recited in claim 16 wherein said challenge is at least pseudorandom.

18. The method as recited in claim 16 wherein said challenge is encrypted with a public key unique to said wireless communication device.

19. The method as recited in claim 16 further comprising generating an access request containing a public ID of said wireless communication device.

20. The method as recited in claim 16 wherein said wireless communication device is a wireless telephone.
